(19) United States
(12) Patent Application Publication
(10) Pub. No.: US 2024/0383165 A9
(43) Pub. Date: Nov. 21, 2024

(54) System And Method for Transitioning Assets to New Risk Frameworks

(71) Applicant: The Toronto-Dominion Bank, Toronto (CA)

(72) Inventors: Zhongguo YANG, Princeton, NJ (US); Andrew GUNSTENSEN, Princeton, NJ (US)

(73) Assignee: The Toronto-Dominion Bank, Toronto (CA)

(21) Appl. No.: 18/313,539

(22) Filed: May 8, 2023

(51) Int. Cl. B26D 7/26; B26D 1/00; B26D 1/06; B26D 7/28

(52) U.S. Cl. CPC B26D 7/2614; B26D 1/0006; B26D 1/06; B26D 7/28; B26D 2001/0013; B26D 2001/0033; B26D 2210/06

(57) ABSTRACT

A device, method, and computer readable medium are provided for transitioning risk analysis. The method includes providing a first risk assessment, and providing a second risk analysis program that generates risk assessments based on a transformation model configured to convert risk based on (1) a first reference rate, and (2) one or more risk functions for one or more first instruments, into risk based on a second reference rate. The method includes generating a second risk assessment with the second risk analysis program, based on the first risk assessment and one or more target instruments that incorporate risk based on the second reference rate, the one or more target instruments being associated with a product or service.

### TECHNICAL FIELD

The following relates generally to risk management, and in particular to transitioning existing risk management approaches to new risk management approaches.

### BACKGROUND

Existing approaches to risk management have relied upon well-accepted standards. However, risk management approaches are now being reconsidered for a variety of reasons, including as a result of the London Interbank Offered Rate (LIBOR) being phased out.

More generally, existing risk management approaches can be inflexible, and difficult to adapt to changing circumstances. For example, transitioning risk management approaches in response to LIBOR's phase-out is technically challenging. The challenges can include being able to accurately extract institutional knowledge with respect to products, models, datasets, and more generally processes captured in existing approaches. For example, a particular model used for rate risk determination can include incremental modules and adjustments introduced over a long time span, rendering their extraction difficult. The challenges can include creating a robust transition mechanism that can be incorporated into different environments for different purposes. For example, risk management frameworks can exist in a large institution and inform a variety of different products. The risk management framework can extend into, and require the support of, a variety of different computing architectures. Another challenge is to implement a solution that respects existing security processes. Moreover, not only does the transition have a wide scope, but the transition is to be accurate. The potential for loss with inaccurate risk modelling is well known. The framework that is adopted after the transition can be structurally different. For example, SOFR is an overnight lending rate, as compared to LIBOR which is a term rate. The transition should avoid introducing sources of inadvertent, unquantifiable, or otherwise undesirable risk.

The surviving risk management framework may be forced to rely on new models, or new data sources. These sources of newness can be difficult to integrate, retrieve, manage, etc.

Implementing a smooth, effective, efficient, robust, cost-effective, etc., transitioned risk management framework is desirable.

### BRIEF DESCRIPTION OF THE DRAWINGS

Embodiments will now be described with reference to the appended drawings wherein:

FIG. 1 is a schematic diagram of an example computing environment for risk analysis.

FIG. 2 is a block diagram of an example workflow for implementing risk analysis in accordance with the disclosure herein.

FIGS. 3A and 3B are each an example graphical user interface of an example risk analysis platform.

FIG. 4 is a block diagram of another example workflow for implementing risk analysis in accordance with the disclosure herein.

FIGS. 5A and 5B show, respectively, an example input to, and output of a risk analysis platform.

FIG. 6 is a block diagram of an example configuration of a risk platform.

FIG. 7 is a block diagram of an example configuration of an enterprise system.

FIG. 8 is a block diagram of an example configuration of a computing device associated with a user, customer, or client.

FIG. 9 is a flow diagram of an example of computer executable instructions for processing hierarchical data.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It is understood that the use of the term “risk model,” also referred to as a “risk framework” is not intended to be limited to a particular model type (e.g., a multi-stage model, a framework solely to addressing USD to CAD currency risk, a neural network, etc.), or a particular implementation of a model (e.g., limited to a particular computing language), and that an expansive definition of the term is intended unless specified otherwise. For example, the risk model can store information in different formats, can be stored on different media (e.g., a database, a portable data drive, etc.). The risk model may not necessarily be an independent file, and can be part of a data file, or include a routine, method, object, etc.

This disclosure relates to approaches for transitioning or retrofitting risk analysis from a first approach to a second approach based on a second reference rate, where the second approach is based on instruments with different properties than the first approach. The differing properties make transition difficult. The proposed transitioning can occur by performing a mapping from the first approach into a second approach based on a target set of instruments, where the mapping process determines the impact of bumping target curve model rates on the first approach model rates. The mapping can be a multi-stage mapping, where different stages isolate risk from different sources.

In one aspect, there is provided a method for transitioning risk analysis. The method includes providing a first risk assessment, and providing a second risk analysis program that generates risk assessments based on a transformation model configured to convert risk based on (1) a first reference rate, and (2) one or more risk functions for one or more first instruments, into risk based on a second reference rate. The method includes generating a second risk assessment with the second risk analysis program, based on the first risk assessment and one or more target instruments that incorporate risk based on the second reference rate, the one or more target instruments being associated with a product or service.

In example embodiments, the method includes determining whether to execute the product or service in response to the second risk assessment satisfying a threshold based on the second reference rate.

In example embodiments, the first reference rate is determined by a LIBOR based instrument, and the second reference rate is determined with a SOFR based instrument. In example embodiments, at least one of the first set of instruments is structurally different than at least one corresponding instrument of the one or more target instruments, and the transformation model converts risk from the at least one corresponding instrument into a replacement instrument aligned with the corresponding instrument of the first set of instruments.

In example embodiments, the transformation model converts risk at least in part by evaluating currency risk for the one or more first instruments by converting at least some of the one or more first instruments into replacement instruments with a first structure, where the first structure corresponds to a structure of corresponding instruments of the one or more target instruments, and the replacement instruments differ from the corresponding target instruments in terms of currency funding.

In example embodiments, the transformation model converts risk in two or more stages, each stage being configured to isolate a different risk. In example embodiments, at least one stage of the two or more stages isolates cross currency funding risk, and another of the two or more stages isolates misalignment risk. In example embodiments, a further stage of the two or more stages receives an outcome of the at least one and other stage and converts the determined risk into the one or more target instruments.

In example embodiments, the method includes validating the second risk assessment by comparing the second risk assessment to a reference risk assessment.

In another aspect, a device for transitioning risk analysis is disclosed. The device includes a processor, a communications module coupled to the processor, and a memory coupled to the processor. The memory stories computer executable instructions that when executed by the processor cause the processor to provide a first risk assessment. The instructions cause the processor to provide a second risk analysis program that generates risk assessments based on a transformation model configured to convert risk based on (1) a first reference rate, and (2) one or more risk functions for one or more first instruments, into risk based on a second reference rate. The instructions cause the processor to generate a second risk assessment with the second risk analysis program, based on the first risk assessment and one or more target instruments that incorporate risk based on the second reference rate, the one or more target instruments being associated with a product or service.

In example embodiments, the instructions cause the processor to determine whether to execute the product or service in response to the second risk assessment satisfying a threshold based on the second reference rate.

In example embodiments, the first reference rate is determined by a LIBOR based instrument, and the second reference rate is determined with a SOFR based instrument.

In example embodiments, at least one of the first set of instruments is structurally different than at least one corresponding instrument of the one or more target instruments, and the transformation model converts risk from the at least one corresponding instrument into a replacement instrument aligned with the corresponding instrument of the first set of instruments.

In example embodiments, the transformation model converts risk at least in part by evaluating currency risk for the one or more first instruments by converting at least some of the one or more first instruments into replacement instruments with a first structure, where the first structure corresponds to a structure of corresponding instruments of the one or more target instruments, and the replacement instruments differ from the corresponding target instruments in terms of currency funding.

In example embodiments, the transformation model converts risk in two or more stages, each stage being configured to isolate a different risk. In example embodiments, at least one stage of the two or more stages isolates cross currency funding risk, and another of the two or more stages isolates misalignment risk. In example embodiments, a further stage of the two or more stages receives an outcome of the at least one and other stage and converts the determined risk into the one or more target instruments.

In example embodiments, the instructions cause the processor to populate one or more risk buckets with the one or more target instruments to reflect risk in the corresponding buckets.

In example embodiments, the instructions cause the processor to validate the second risk assessment by comparing the second risk assessment to a reference risk assessment.

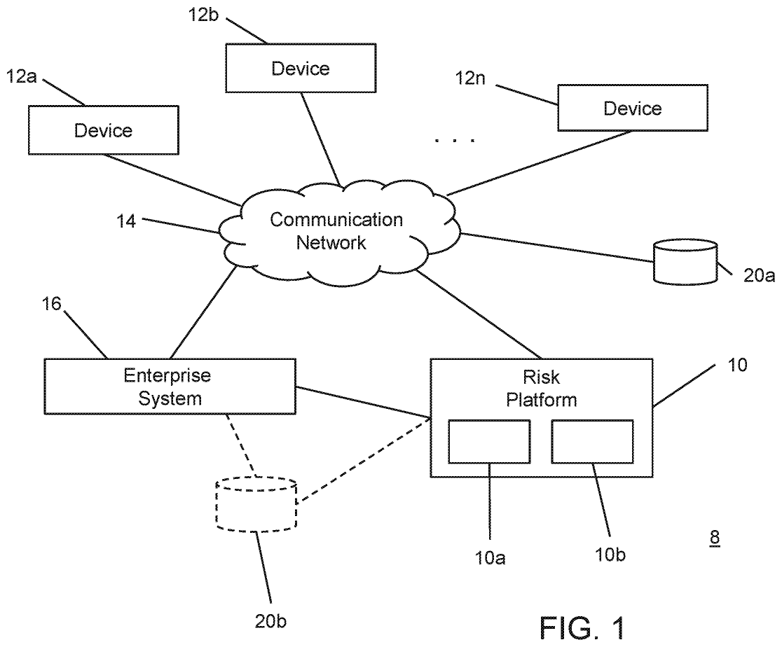

Referring now to the figures, FIG. 1 illustrates an exemplary computing environment 8. The computing environment 8, as shown, includes a risk platform 10, an enterprise system 16 in need of risk management, one or more client devices 12 (shown by client devices 12a, 12b . . . 12n, hereinafter referred to in the singular for ease of reference), a source(s) of data elements, such as the shown external data storage 20a, or the internal data storage 20a (hereinafter referred to in the singular for ease of reference) (or both), and a communications network 14 connecting one or more components of the computing environment 8. It is understood that while the elements within the environment 8 are shown as distinct, differing degrees of integration are contemplated. For example, the risk platform 10 can be part of the enterprise system 16.

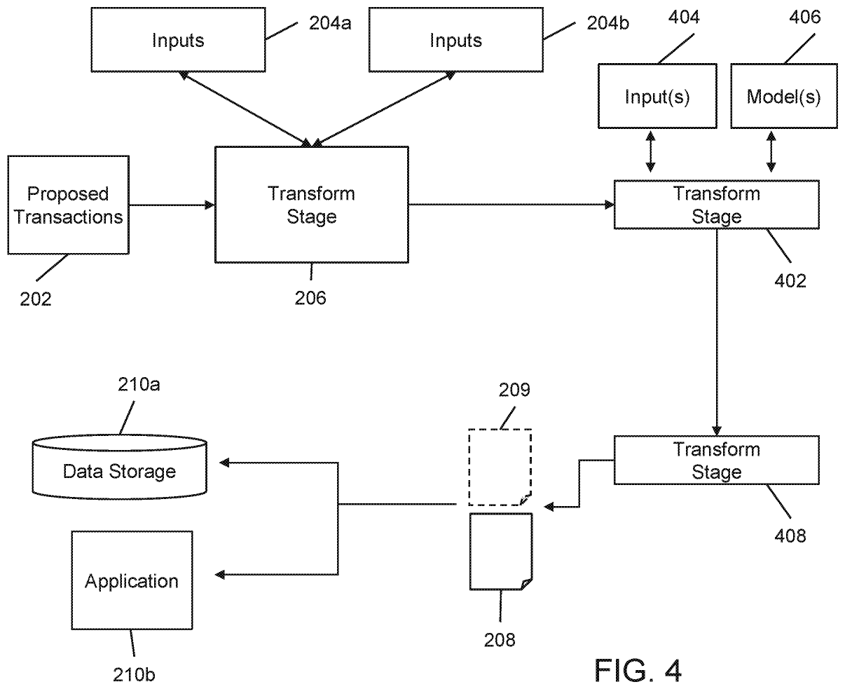

The enterprise system 16 can be a financial institution, such as commercial bank and/or insurance provider, which provides services to users (e.g., processes financial transactions) which require, directly or indirectly, a quantification of risk, or more generally the use of a risk management system. The enterprise system 16 can include different components, which components have been omitted from FIG. 1 for clarity. Some of the potential components are discussed in FIG. 4, below, with additional detail.

The datastore 20 includes data used to determine risk by the risk platform 10. This disclosure identifies a few types of data, but it is understood that this disclosure is not limited solely to the types of data discussed. In example embodiments, the datastore 20 includes data related to different financial instruments, such as market or historical prices for securities. For example, the datastore 20 can include historical or market data for interest rate swaps for particular currencies (e.g., Canadian dollar vs US dollar swaps). In another example, the datastore 20 includes data for mortgage instruments, such as maturity, rate, currency, etc. In yet another example, the datastore 20 can include historical or market data for corporate bonds, equities, or enterprise system 16 lending and deposits, etc. In yet another example, the datastore 20 can include the maturity date of an interest rate swap, the trading volume of the instrument or related instrument, the exchanges upon which the swap trades, the Secured Overnight Financing Rate (SOFR), parameters related to the availability of the swap (e.g., amount asked for, bid/ask spread, etc.), etc.

The datastore 20 can be automatically updated, periodically updated, updated only on command, etc. Different data stores 20 can have access to different data sources and contain different data. For example, internal data stores 20 can store historical data for the enterprise system 16, and therefore be used to identify risk for historical transactions.

The datastore 20 can include sensitive data. The sensitive data can include asset information, correspondence data (e.g., team, intranet, messaging, committee, or other client- or relationship-based data), proprietary data that is used to assess risk (e.g., trading strategies, etc.), etc.

The datastore 20 can be secured separately from, or as part of, the enterprise system 16. For example, the datastore 20 can be within a cloud computing environment of the enterprise system 16, or separately secured, etc.

The risk platform 10 is for transitioning risk analysis approaches. The risk assessed can be related to a variety of different products, transactions, reference rates, services, etc. For example, the risk can relate to interest rate swaps, adjustable-rate mortgages, corporate lending and deposits and others.

The risk platform 10 can implement a risk analysis to transition or retrofit existing risk analysis approaches (e.g., a legacy, LIBOR based risk assessment system of enterprise system 16). In an example, transitioning can include converting from an existing risk analysis approach contingent upon particular input instruments (e.g., a security, benchmark, index, etc.), and based on certain parameters (e.g., estimate yield curves), into another risk approach based on different parameters and/or different instruments (referred to hereinafter as target instruments). The parameters and/or instrument data output and consumed by the platform 10 can be different in kind, or different in degree (e.g., the same securities having different durations, etc.). The term “different parameters,” can refer to different compositions of the same parameters (e.g., the different parameters include different emphasis being assigned to the same security), etc.

In FIG. 1, the risk analysis performed based on, or reflecting risk in a first reference rate is shown by risk platform 10a, whereas risk analysis that retrofits or transitions an existing risk analysis to an analysis based on, or reflecting, risk based on a second rate of reference is shown as platform 10b.

In example embodiments, the risk platform 10b can perform risk analysis at first instance. For example, the risk platform 10 can perform risk analysis for the same inputs (e.g., trades) based on different parameters to generate different views for understanding the risk associated with the input(s).

By generating a risk assessment with the risk platform 10b based on a risk assessment with an existing system, the disclosed system can at least in part overcome the technical challenge of capturing institutional knowhow captured in the existing systems. That is, the institutional know-how is captured in the first risk assessment, and this first risk assessment forms the basis of the risk assessment transition implemented by the risk platform 10b.

In at least some embodiments, the risk platform 10b is used to quickly transition historical risk assessments. Specific models (as that term is described herein) can be generated to facilitate rapid conversion of historical risk assessments. The risk platform 10b is also robust, in that it can be adapted to respond to different historical risk assessments by adjusting the ingestion procedures.

The risk platform 10 can have access to various different data or tools. For example, the risk platform 10 can have access to the datastore 20, or another datastore to retrieve risk analysis tools, etc. The risk platform 10 can perform different functions of the risk analysis on different computing environments or platforms. For example, the risk platform 10 can aggregate data from the data stored 20 on a first dedicated server, perform the risk analysis on a cloud-based processor, and generate reports on a third server.

The risk platform 10 can be automatically initiated, (e.g., in response to a potential trade being submitted to the enterprise system 16), instantiated via dedicated command, etc.

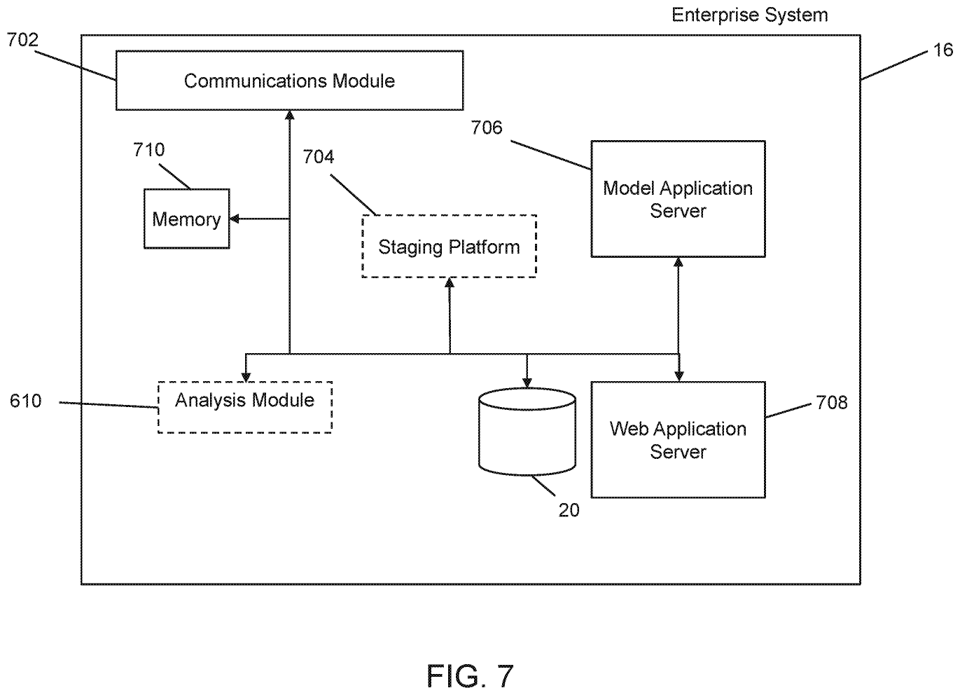

It can be appreciated that while the components of the environment 8 are shown as separate entities in FIG. 1, they may also be part of the same system. For example, the risk platform 10 can be hosted and provided within the enterprise system 16 as illustrated in FIG. 7.

Client device 12 can be associated with one or more users that directly or indirectly interact with the risk platform 10. Users may be referred to herein as employees, customers, clients, consumers, correspondents, or other entities that interact with the enterprise system 16 and/or risk platform 10 (directly or indirectly). The computing environment 8 may include multiple client devices 12, each client device 12 being associated with a separate user or associated with one or more users. In certain embodiments, a user may operate client device 12 such that client device 12 performs one or more processes consistent with the disclosed embodiments. For example, the user may use client device 12 to engage and interface with the risk platform 10 as well as mobile or web-based applications provided by the enterprise system 16, which is provided within or is complementary to the risk platform 10 to perform risk analysis. In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, and any additional or alternate computing device, and may be operable to transmit and receive data across communication network 14.

Communication network 14 may include a telephone network, cellular, and/or data communication network to connect different types of client device 12, enterprise system 16, datastore 20, and/or risk platform 10. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network, and a private and/or public wide area network (e.g., the Internet).

The risk platform 10 may be associated with one, or more than one enterprise. In certain embodiments risk platform 10 may represent or be part of an enterprise. For example, the risk platform 10 may be a system within a commercial bank (e.g., enterprise system 16). The risk platform 10 can be provided be a third-party service provider, and at least in part integrated with a single enterprise (e.g., a business which performs data analysis, such as a cloud computing provider). The risk platform 10 can also operate as a standalone entity that is configured to serve multiple enterprises.

The risk platform 10 and/or enterprise system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the risk platform 10 and/or enterprise system 16. The cryptographic server may be used to protect, for example, at least some data in the datastore 20, such as the underlying data, the risk analysis parameters, or the risk analysis models, etc., by way of encryption for data protection, digital signatures or message digests for data integrity, and by using digital certificates to authenticate the identity of the users and client devices 12 with which the enterprise system 16 and/or risk platform 10 communicates to inhibit data breaches by adversaries. It can be appreciated that various cryptographic mechanisms and protocols can be chosen and implemented to suit the constraints and requirements of the particular deployment of the risk platform 10 or enterprise system 16 as is known in the art.

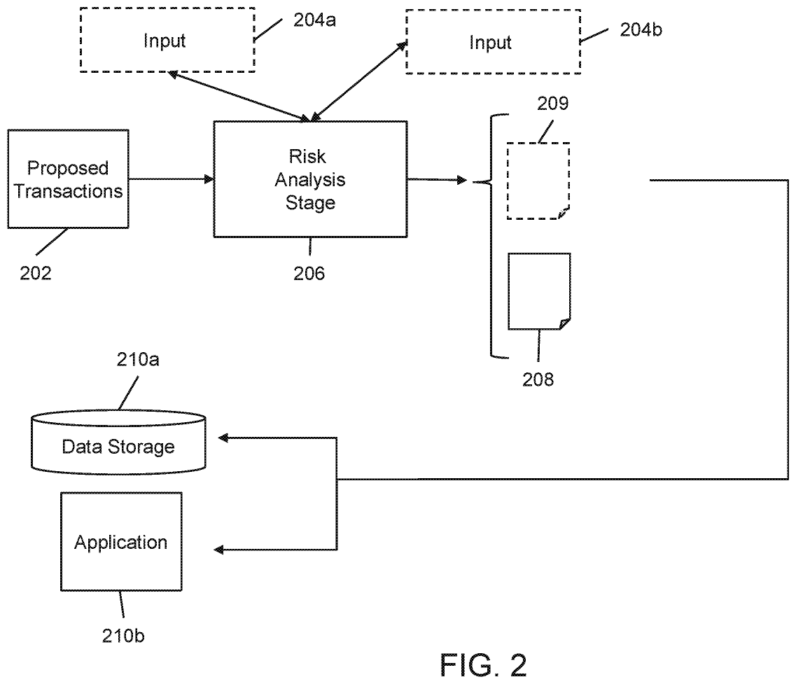

FIG. 2 is an example workflow for implementing risk analysis with the risk platform 10b. The example in FIG. 2 is shown with respect to LIBOR dependent instruments, but it is understood that this example is non-limiting.

A transaction, service, or a prospective transaction or service 202 (hereinafter the transaction 202, for simplicity), is proposed, or has been executed. The transaction 202 can include offering securities or other products (e.g., a proposed security, or index), or a prospective transaction of opening a bank account with a particular deposit rate, or offering a mortgage with a particular interest rate in a particular currency, etc., or an existing or previously offered equivalent.

One or more inputs 204 are provided to a risk analysis stage 206 of risk platform 10b. For illustrative purposes, the inputs 204 are shown separately as inputs based on risk platform 10a, and inputs for risk platform 10b to perform risk analysis transition. The inputs can include parameters such as risk buckets (e.g., output risk buckets from risk platform 10a, and target risk buckets for risk platform 10b to evaluate), constituent instruments, locations of data sources, etc.

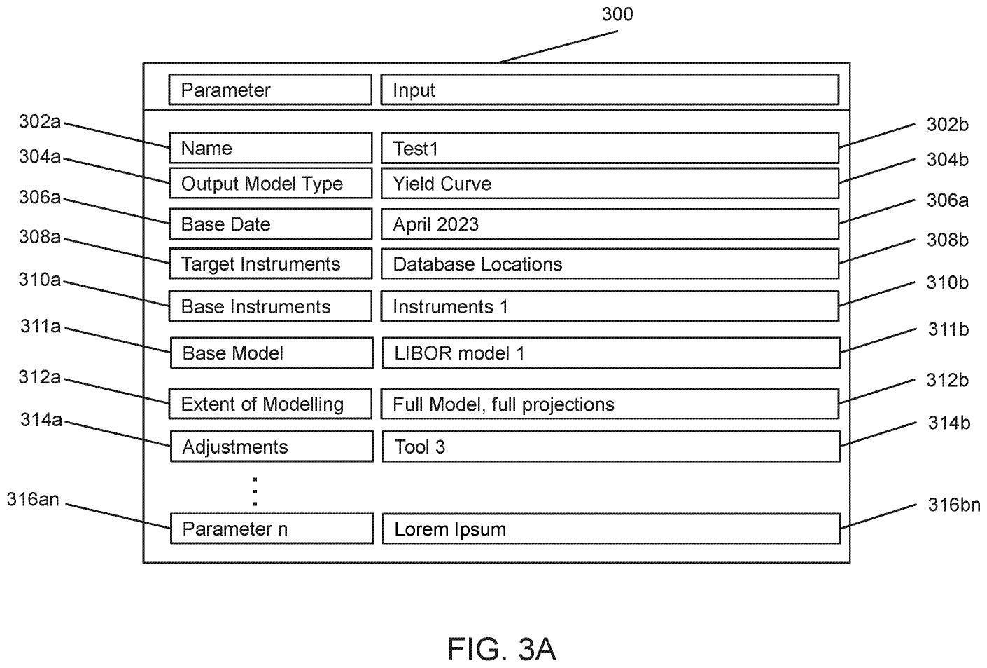

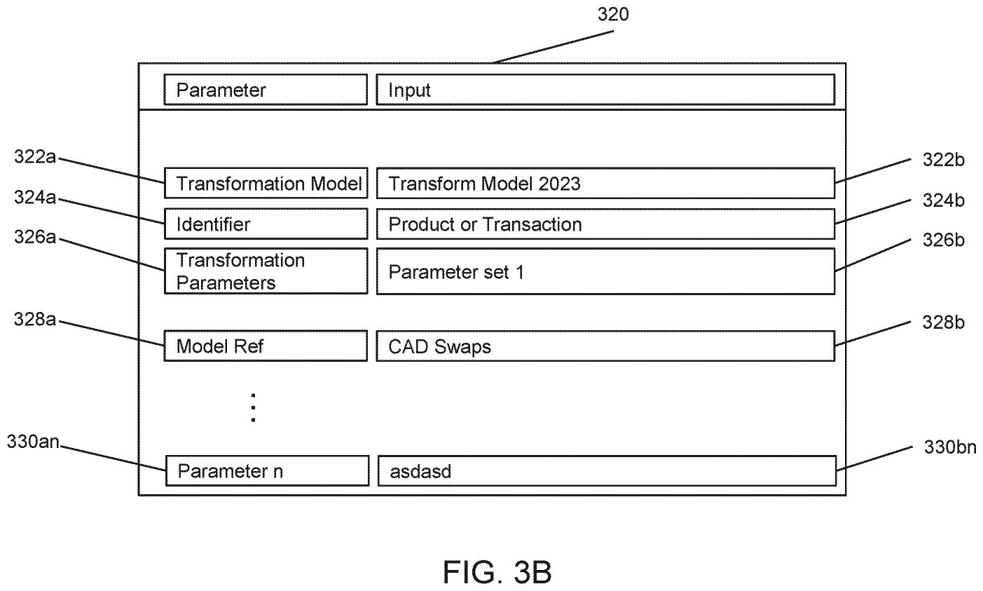

FIG. 3A shows an example graphical user interface (GUI) 300 for receiving inputs 204 into the risk analysis stage 206.

As shown in FIG. 3A, the inputs (the shown GUI 300 includes a label, denoted with the suffix ‘a’, and a portion where input is received, denoted by suffix ‘b’, where the input will be referred to generally for ease of reference) can include a name of the transaction (portion 302), an expected output of the risk analysis stage 206 (portion 304), a date(s) for the proposed transaction (portion 306), a set of target instruments (portion 308), one or more instruments used to complete a first risk assessment, by, for example, the risk platform 10a (portion 310), a first risk assessment program or related risk model used to initiate risk analysis of the one or more instruments received in portion 310 (portion 311), an indication of the extent of the modelling (portion 312), an input for adjustments which can be particular to the transaction being offered (portion 314), and so forth (shown as portion 316).

In at least some example embodiments, GUI 300 is used to, or more generally the risk analysis stage 206 is used to generate a transformation model that converts risk present in the one or more instruments (i.e., input in portion 310) based on a first rate of reference (e.g., LIBOR, which is built into the model received in portion 31), to risk based on one or more second instruments (i.e., input in portion 308, and alternatively referred to as the target instruments) reflecting risk based on a second reference rate (e.g., SOFR).

Portion 304 can reflect whether a yield curve model, or another model (e.g., a spread model) is being used to estimate risk.

Portion 306 can reflect the temporal elements associated with the transaction. For example, the transaction can specify a duration (e.g., a 5-year mortgage), etc.

Portion 308 can reflect the target set of instruments that reflect risk based on the second reference rate. The target instruments can be derivatives of the second reference rate. The target set of instruments can include a variety of different instruments, including outright futures, interest rate swaps, etc.

The target set of instruments can be selected to respond to one or more risk parameters. The risk parameters can include so called ‘buckets,’ alluded to above. where each bucket reflects risk from a different aspect. The risk parameters can be temporal, based on a particular instrument, a particular risk (e.g., currency risk, interest rate risk, etc.), etc. The target set of instruments can directly respond to a bucket, or indirectly (e.g., a risk parameter can be estimated based on a combined curve of a plurality of target instruments).

The target set of instruments at least in part overlaps with the first set of instruments. Overlap, as that term is used herein, describes incorporating a similar type of risk. For example, the target set of instruments that address currency risk (e.g., a forward instrument) overlaps with instruments of the first set of instruments that include currency risk but are also based on the first rate of reference.

In at least some example embodiments, an aspect of the risk analysis stage 206 can include generating a transformation model 208 to transform risk evaluated based on the base set of instruments, and base model, and associated parameters, into a risk based on the target set of instruments and associated parameters. The transformation model 208 can include the transformation model 208a (e.g., a transformation matrix), and related metadata 208b, separately (as shown), or the model 208 can be unitary.

The following is an example methodology to generate a transformation model 208 to generate a risk assessment generated based on the first set of instruments (portion 310) and a first risk assessment program or related risk assessment model (portion 311), into a risk assessment based on the second set of instruments (portion 308). It is understood that the example is not intended to be limiting and is instead intended to be illustrative. The described methodology includes a second risk analysis program that transforms the input interest risk computed by a first risk assessment program with respect to a first set of instruments (e.g., an original yield curve related to said instruments) to the interest risk with respect to a target set of instruments (e.g., a yield curve related to said instruments). The second risk analysis program can operate to generate a risk transformation matrix and apply this matrix on the input risk to provide a transformed risk.

The example method starts with the original yield curve, denoted by YC. The YC is based on calibrating a set of n instruments I, where I represents the specification of the input instrument of unit size to observed par rates for each instrument r with the calibration function C( ), as set out below.

YC=C(I,r)

The target transform curve YC′ is considered (quantities with a ′ will refer to the target set of instruments and related aspects (e.g., a yield curve for a target instrument, and values computed with respect to this curve)). The par rates are computed for target instruments from the original yield curve.

rⱼ′=R(YC,Iⱼ′)

The target curve YC is calibrated based on the following.

YC′=C(I′,r′)

The first delta (as shown below), computed by the first risk analysis program, is considered.

Δi=∂PV(trade)/∂rᵢ

The second risk assessment program generates a matrix of sensitivities of the original curve instruments to the original curve inputs, based on the equation shown below. This can have elements only on the diagonal since a curve input instrument is only sensitive to the par rate of that instrument.

$${Λ}_{ij} = \{ \begin{matrix}\partial PV ( {I}_{i} ) / \partial {r}_{j} FOR i = j \\ 0 FOR i \neq j\end{matrix}$$

The computation of the matrix of sensitivities of each of the original curve instruments Iᵢ to the new curve structure Λ′ (i.e., based on the target instruments) is determined based on the below.

Λ′ᵢⱼ=∂PV(Iᵢ)/∂r′ⱼ

Note that Δ^{T}Λ⁻¹ is a matrix with the notional equivalent of each original curve input instrument that generates the input risk Δ along the diagonal and all off diagonal elements set to 0. Multiplying this by the unit sensitivities of the original instruments to the new curve structure gives us the risk with respect to the new structure.

Δ′=Δ^{T}Λ⁻¹Λ′

The next step is to compute the transform matrix Λ⁻¹Λ′ once and use this to transform an arbitrary number of delta strips computed against the original curve. In at least one aspect, the transform matrix can reflect the impact of bumping the target curve model rates on the base model rates.

The extent of the modeling performed as set out above can be controlled to the extent input in portion 312. For example, the portion 312 can receive input that full projections are to be made for each instrument set, or that partial projections are to be made (e.g., to avoid the computational cost associated with full projections), etc.

Portion 314 can receive input that makes one or more adjustments to the input information, or input models. For example, portion 314 can be used to specify certain formatting operations to input information to ensure compliance with the model, to enable robustness. In another example, portion 314 can be used to limit the amount of a particular data set used, or to use a particular facet of an input model, etc. In example embodiments, portion 314 receives input as to where to store resulting models, how they are stored (e.g., compressed or otherwise), the access control information, etc.

Once the transformation model 208 is generated, it can be automatically updated based on newly received source information, or periodically updated, or used as-is in a version controlled environment, etc.

Referring again to FIG. 2, various aspects for analyzing risk are shown. In one aspect, the transformation model 208 is applied in the stage 206 to the input proposed transactions 202, and a second risk assessment 209 is generated (where the first risk assessment is the risk assessment from input 204a). The risk assessment 209, similar to the model 208, can be provided to the application 210b or a database 210a. More particularly, the transformation model 208 can be applied to a risk assessment that is not generated by the risk platform 10a (not shown) to generate the transformed risk. The risk assessment can be a collection of individually generated yield curves, for example, for individual instruments related to the proposed transaction.

In another aspect, FIG. 2 depicts the transformation model 208 being generated and thereafter being stored in a database (e.g., database 210a) for use when required, or provided directly to an application (e.g., application 210b), etc.

The application 210b can compute a transformed risk with the model 208 in place of determining the risk with the platform 10a. That is, the application 210b receives an input risk to be assessed (e.g., in place of transaction 202) for a target set of instruments (inputs 204), and determines the transitioned risk by at least in part multiplying the input risks by the transformation model 208. This implementation can enable rapid dissemination of the transitioned risk analysis approach. For example, the application 210b can be a risk assessment program provided within the enterprise system 16 to ensure uniform risk assessment, or to enable consistent monitoring and reporting of activities within the system 16.

One such example is shown in FIG. 3B, with the application 210b incorporating a GUI 320 that can enable the use of a model 208 in a variety of different computing environments, for different uses. In the shown GUI 320, inputs responsive to: which model 208 to use (e.g., in the instance of many models 208 being available)(portion 322), the input risks for conversion (portion 324), transformation parameters (portion 326), and other inputs (portion 330) can be received or provided.

The transformation parameters received or provided in portion 326 can be responsive to valuation parameters, or to input data, etc. In example embodiments where the transformation parameters include a valuation model, the parameters can include thresholds associated with the valuation that are required to be satisfied in order for the risk assessment to be actionable. For example, the valuation and related threshold can be assessed as follows:

In order to ensure the transformation model 208 works as expected, a valuation metric can measure the relative Price Value of a Basis Point (PV01) difference between the pair of the PV01 of the transformed baseModel valuation risk buckets (the first risk assessment) and the PV01 of targetModel valuation risk buckets (the second risk assessment) for each of all the baseModel curve instruments:

PV01Diff(I,C)=|TransformedPV01(I,C)−TargetPV01(I,C)|/MaxTargetPV01(I)

Where, I is a baseModel curve instrument, C is a curve in targetModel, PV01 Diff(I, C) is the metric computed for targetModel curve C PV01s for baseModel curve instrument I, and TransformedPV01(I,C) is the PV01 of the transformed baseModel valuation risk buckets.

TransformedPV01(I,C) can be computed as follows: 1. valuate baseModel curve instrument I under baseModel (e.g., the model input in portion 311), compute baseModel first order risk, 2. transform these first order risk buckets to targetModel risk buckets using the transformation model 208, and 3. compute curve C PV01 by summing all the transformed curve C risk buckets.

In the valuation metric, TargetPV01(I,C) is the PV01 of the targetModel valuation risk buckets. It can be computed as follows: 1. valuate baseModel curve instrument I under targetModel (e.g., model 208), compute targetModel first order risk, and 2. compute curve CPV01 by summing all the curve C first order risk buckets.

In the valuation metric, MaxTargetPV01(I) is max {|TargetPV01(I,C)|:C over all targetModel curves}.

The valuation metric can be calculated periodically, on demand, or otherwise. In example embodiments, the valuation metric can be calculated for each of the target instruments and each of the first set of instruments on a daily basis.

If the valuation metric fails to satisfy a threshold, the product or service for which risk is being evaluated can be rejected (or, in the opposite situation, executed).

The threshold can be set to a valuation metric outcome (e.g. 5%), or a dollar value, etc. The threshold, as a result of incorporating the targetModel curves, is inherently at least in part based on the second reference rate. As a result, the metric represents another shift which enables evaluation without exclusively relying on the first reference rate.

Portion 328 can be populated based on the user inputs to provide metadata or other clarifying information to ensure that correct selections have been made.

In example embodiments, a transformation model 208 is generated based on a multi-stage process, where each stage of the process focuses on a particular type of risk.

Referring now to FIG. 4, an example workflow for implementing risk analysis with a multi-stage transformation is shown. Multiple stage risk transformations can be used to apply intermediate risk transformation models to transform the input “baseModel,” with its accompanying parameters (e.g., risk buckets), to intermediate parameters, (e.g., risk bucket set RB1, intermediate risk bucket set RB2, etc.), to a target set of parameters (e.g., risk buckets). A multi-stage risk transform function can be appropriate where a single stage transformation is unable to transform the input risk buckets to produce the accurate results. It has been found that adding additional stage(s) to the risk transformation function can address inaccuracies in at least some instances.

The multi-stage risk transformation can be configured such that each stage receives at least some information from the preceding stage(s). For example, the second stage risk transformation model's baseModel can be the preceding stage's targetModel. The final transformation function 208 can be defined as the multiplying the stage's intermediate transformation functions together (e.g., multiplying the intermediate transform matrices to generate the final transformation model matrix).

In the embodiment shown in FIG. 4, the stage 206 shows a first stage risk transformation for handling currency risk in the forms of cross-currency swaps for funding, a second stage 402 is responsive to risk misalignment arising from structurally different inputs (e.g., input yield curves), and a third stage 408 performs transforms to arrive to the final transformation model 208 that is responsive to the target set of instruments.

In respect of the first stage 206, the first risk platform 10a can implement a curve family that uses a Libor funded combined curve for cross-currency funding and the cross-currency curve can have foreign exchange derived deposits on the cross-currency swaps spread curve. However, the cross-currency funding in the target Model can be required to use SOFR funding.

In order to transition the risk analysis, the stage 206 intermediate risk transformation model can be implemented to convert the cross-currency funding by adjusting the instruments to use the same structure (e.g., index) in both baseModel and targetModel. One approach to implementing such an adjustment is therefore to isolate the cross-currency funding risk buckets. The first stage risk transformation 206 can therefore be set to limit, to the extent possible, all the cross-currency swap funding risks to curve instruments only, and to avoid risk buckets containing cross-currency swap funding risk after the first stage 206. This can be achieved by setting all of the cross-currency swap curve instruments to isolating instruments (e.g., generic forwards) that incorporate a funding index (e.g., CADSOFR1D) being a currency index. Unlike cross-currency swaps, whose structure requires other indexes for valuation, the isolating instruments' structure depends on the currency funding index. The isolating instruments can therefore be viewed as fixed deposits valuated with the currency funding curve as the discounting curve. All currency funding risks will be reflected in buckets generated based on these currency isolating instruments and other buckets inclusion of currency funding risk should be minimized.

In addition, in stage 206, the single currency basis swap curve instruments for an index can be replaced by outright swaps for the same curve index with the same tenor or start date and end date schedule. Furthermore, the outright curve instruments can stay the same without any change.

Referring now to the second stage 402, this stage can be configured to isolate risk associated with exposure to the same curve on structurally different inputs.

The second stage 402 can be required where there is an exposure to the same input (e.g., a LIBOR curve) on two structurally different inputs. The difference in structure may pertain to a misalignment of the input curve node dates associated with the baseModel and targetModel inputs. For instance, the baseModel can include USD Libor6M as an input curve. This input curve can contain Libor3M Futures as base instruments, which produce International Money Market (IMM) node dates. Moreover, the targetModel input curve can have node dates that are implied by tenors (such as 6M, 1Y, 2Y, etc.). As such, the input curves of the baseModel and targetModel are structurally different but include exposure to the same basis curves.

During testing, it was assumed that if all currency curve instruments in the targetModel are outright, there would be little or no first reference rate funding risk buckets in the transformed risk with respect to the target model. However, sizeable first reference rate funding risk buckets were observed where a single stage risk transformation was applied for such a trade. A two-stage transformation provided promising results to address this issue by changing all the basis swaps to outright swaps in stage-one, without changing the node date structure.

The second stage 402 risk transform can be performed by taking the stage 206 target model as the baseModel (shown as input 406) and setting the currency funding indexes other than the desired currency as an outright curve with foreign exchange derived forward curve instruments (shown as inputs 404). On the target model for stage 402, for a single currency curve, the basis swap curve instruments are replaced by outright swaps of the associated index. For the cross-currency funding curve, the foreign exchange derived forward curve instruments are replaced by final target cross-currency swap instruments.

Referring now to the third stage 408, this stage includes transforming the second stage output to the target risk assessment based on the target set of instruments. The baseModel for stage 408 transformation is the same as the target model of stage 402, with implied quotes from stage 402 baseModel being included. The target model for stage 408 is the transformation model 208.

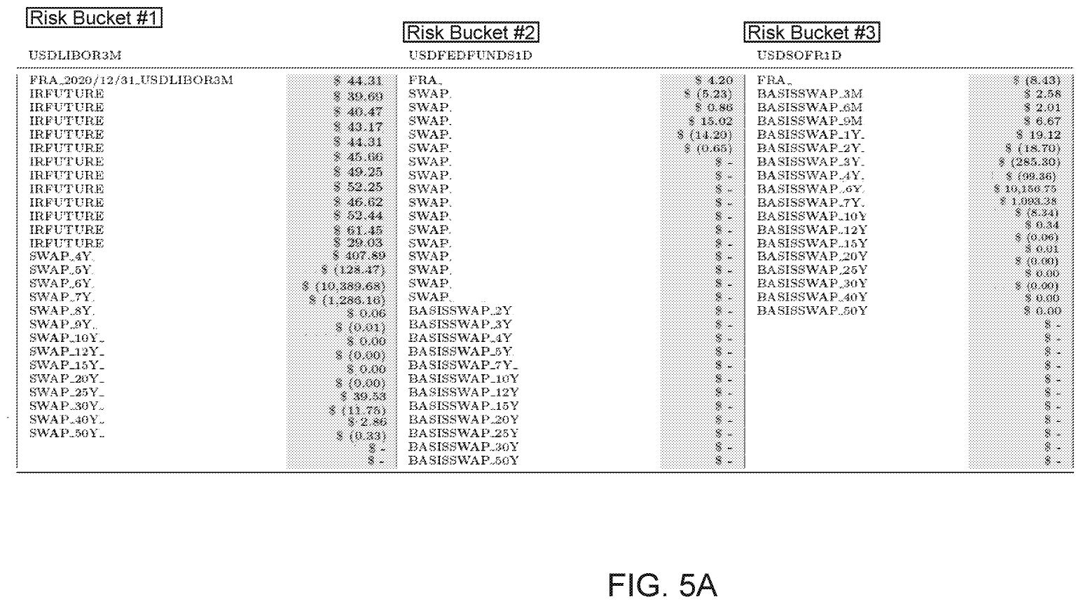

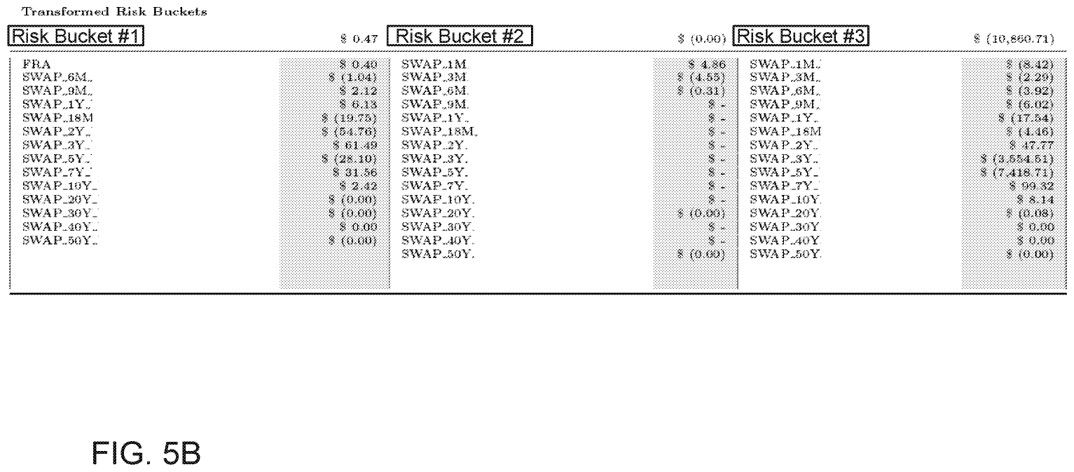

FIG. 5A partially shows an example input (e.g., a combination of input 204 and 202 into an example risk platform 10b, which input is the output of a risk platform 10a). In the shown example, the first, second, and third risk buckets indicate exposure within the respective risk bucket on the basis of the individual instruments (i.e., the first instruments). As is shown in FIG. 5A, the six (6) and seven (7) year swaps for this particular trade, in the first risk bucket, carry the most risk, whereas the basis swaps for the six (6) and seven year (7) basis swaps have the least amount of risk. The instruments which populate the various buckets in FIG. 5A are based on a first reference rate (e.g. LIBOR).

FIG. 5B shows an example output of the risk platform 10b. In the shown example, the risk buckets are the same, whereas the constituent instruments are different. For example, in the third column, the risk is shown as being shifted to different swap instruments (e.g., the target set of instruments), where the different swap instruments reflect risk on the basis of a second reference rate (e.g., SOFR).

The inputs 204 can control the transform stages 206, 402, and 408 based on a requesting or accessing parties' credentials. For example, a foreign exchange trader may have access to a model 208 which can generate transformations for assessing currency risk, whereas a mortgage product director may have access limited to assessing interest rate risk within a relevant market. The inputs 204 (or an aspect of same) can also control the access to the constituent data from datastore 20. For example, the foreign exchange trader will be precluded from accessing firewalled data, whereas a mortgage product director can be prevented from generating models based on data that is irrelevant to mortgages.

The stages 206, 402, and 408 described herein, can be implemented by a single risk platform 10, a single application 210b, or otherwise. For example, the stages can be performed in different applications in the event that a rapid result is required.

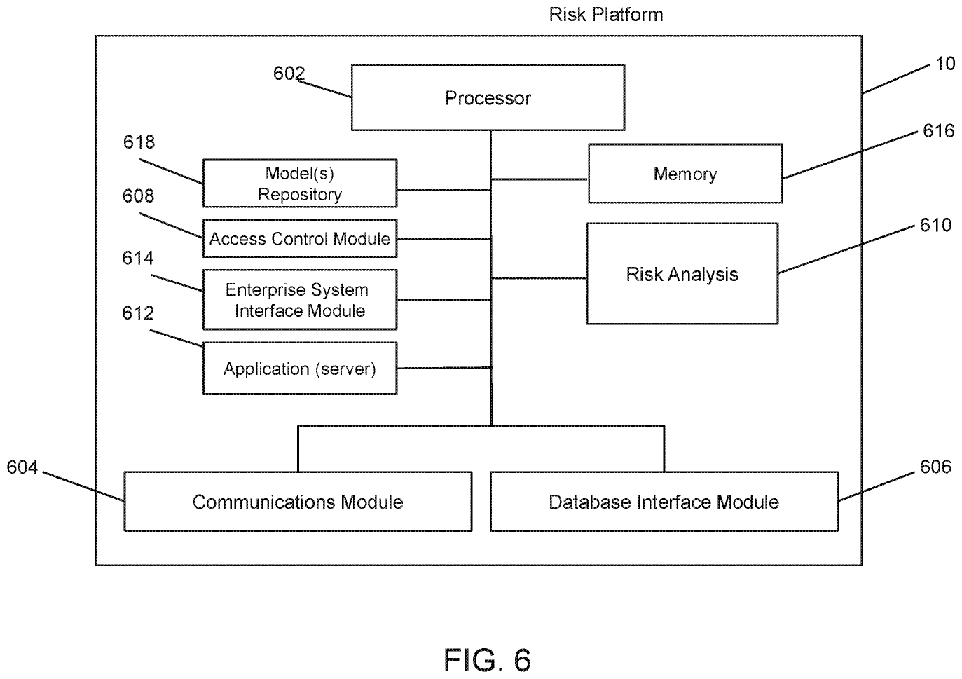

In FIG. 6, an example configuration of the risk platform 10 is shown. In certain embodiments, the risk platform 10 may include one or more processors 602, a communications module 604, and a database interface module 606 for interfacing with the datastores of the datastore(s) 20. Communications module 604 enables the risk platform 10 to communicate with one or more other components of the computing environment 8, such as client device 12 (or one of its components), via a bus or other communication network, such as the communication network 14. The risk platform 10 includes at least one memory 616 or memory device that can include a tangible and non-transitory computer-readable medium having stored therein computer programs, sets of instructions, code, or data to be executed by processor 602. FIG. 6 illustrates examples of modules, tools and engines stored in memory on the risk platform 10 and operated by the processor 602. It can be appreciated that any of the modules, tools, and engines shown in FIG. 6 may also be hosted externally and be available to the risk platform 10, e.g., via the communications module 604. In the example embodiment shown in FIG. 6, the risk platform 10 includes an access control module 608, the risk analysis module 610, the application module 612 for interfacing with external applications, and an enterprise system interface module 614.

The risk platform 10 can also include a model(s) repository 618. The repository 618 can include a plurality of models for different circumstances, to enable rapid conversion of risk associated with a variety of trades and products from the first to the second reference rate. For example, the enterprise system 16 can determine that approximately twenty trades which are similar are regularly made and need to be evaluated with the platform 10b. As a result, the model(s) repository 618 can be configured to

The access control module 608 may be used to apply a hierarchy of permission levels or otherwise apply predetermined criteria to determine what data from datastore 20, can be shared with which entity in the computing environment 8. As such, the access control module 608 can be used to control the sharing of certain data of the enterprise system 16 or other datastore based on a type of client/user, a permission or preference, or any other restriction imposed by the computing environment 8 or application in which the risk platform 10 is used.

The risk platform 10 may also include or host an application 612 that enables client devices 12 to access or control the risk platform 10, and to visualize the risk analysis data. In example embodiments, the application 612 includes an application programming interface (API) to enable functionality of the platform 10 to be accessed via widely available software platforms, such as web browsers. The application 612 may also interface with or be integrated into the enterprise system interface module 614 to permit a seamless integration with existing user interfaces and tools associated with the enterprise system 16.

The enterprise system interface module 614 can provide a GUI or API connectivity to communicate with the enterprise system 16 to obtain enterprise data, or other data in datastore 20 (if applicable). It can be appreciated that the enterprise system interface module 614 may also provide a web browser-based interface, an application or “app” interface, a machine language interface, etc.

In FIG. 7, an example configuration of the enterprise system 16 is shown. The enterprise system 16 includes a communications module 702 that enables the enterprise system 16 to communicate with one or more other components of the computing environment 8, such as client device 12 (or one of its components) or risk platform 10, via a bus or other communication network, such as the communication network 14. The enterprise system 16 includes at least one memory 710 or memory device that can include a tangible and non-transitory computer-readable medium having stored therein computer programs, sets of instructions, code, or data to be executed by one or more processors (not shown for clarity of illustration). FIG. 7 illustrates examples of servers and datastores/databases operable within the system 16. It can be appreciated that any of the components shown in FIG. 7 may also be hosted externally and be available to the system 16, e.g., via the communications module 702.

In the example embodiment shown in FIG. 7, the enterprise system 16 includes one or more servers to provide access to the datastore 20, a staging platform 704, to allocate resources for the platform 10. One or more servers enable the risk platform 10 to interface with existing components, services, departments, and lines of business implemented by the enterprise system 16. Exemplary servers utilized by the enterprise system 16 include an application server 706, and a web application server 708. Although not shown in FIG. 7, as noted above, the enterprise system 16 may also include a cryptographic server for performing cryptographic operations and providing cryptographic services. The cryptographic server can also be configured to communicate and operate with a cryptographic infrastructure. The enterprise system 16 may also include one or more data storages for storing and providing data for use in such services.

Application server 706 supports interactions with the platform 10 directly when a corresponding application is installed on the client device 12 within an enterprise system 16. Application server 706 can access other resources of the enterprise system 16 to carry out requests made by the corresponding application, and to provide content and data to, the corresponding application on client device 12. In certain example embodiments, application server 706 supports an employee mobile desktop, etc.

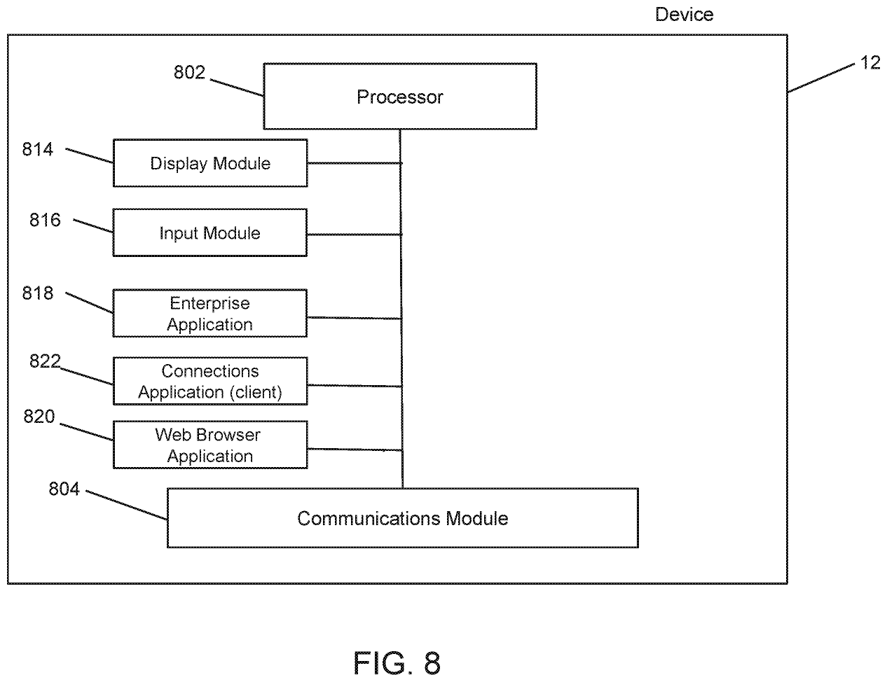

Web application server 708 supports interactions using a website accessed by a web browser application 820 (see FIG. 8) running on the client device 12. It can be appreciated that the application server 706 and the web application server 708 can provide different front endpoints for the same application, that is, the mobile (app) and web (browser) versions of the same application of the platform 10. For example, the enterprise system 16 may provide a security application for access by different employees (or related contractors) that be accessed via a client device 12 via a dedicated application, while also being accessible via a browser on any browser-enabled device.

In FIG. 8, an example configuration of the client device 12 is shown. In certain embodiments, the client device 12 may include one or more processors 802, and a communications module 804. Communications module 804 enables the client device 12 to communicate with one or more other components of the computing environment 8, such as the risk platform 10 or enterprise system 16, via a bus or other communication network, such as the communication network 14. While not delineated in FIG. 8, the client device 12 includes at least one memory or memory device that can include a tangible and non-transitory computer-readable medium having stored therein computer programs, sets of instructions, code, or data to be executed by processor 802. FIG. 8 illustrates examples of modules and applications stored in memory on the client device 12 and operated by the processor 802. It can be appreciated that any of the modules and applications shown in FIG. 8 may also be hosted externally and be available to the client device 12, e.g., via the communications module 804.

In the example embodiment shown in FIG. 8, the client device 12 includes a display module 814 for rendering GUIs and other visual outputs on a display device such as a display screen, and an input module 816 for processing user or other inputs received at the client device 12, e.g., via a touchscreen, input button, transceiver, microphone, keyboard, etc. The client device 12 may also include an enterprise application 818 provided by the enterprise system 16, e.g., for initiating trades or for analyzing existing or prospective products or services. The client device 12 in the shown example embodiment also includes a web browser application 820 for accessing Internet-based content, e.g., via a mobile or traditional website. In this example, the client device 12 also includes a connections application 822, which corresponds to a client-based application to access and interface with the application 612 hosted by the risk platform 10.

It will be appreciated that only certain modules, applications, tools, and engines are shown in FIGS. 6 to 8 for ease of illustration and various other components would be provided and utilized by the risk platform 10, enterprise system 16, and client device 12, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of any of the servers or other devices in risk platform 10 or enterprise system 16, or client device 12, or accessible or connectable thereto. Any application or module herein described may be implemented using computer readable/executable instructions that may be stored or otherwise held by such computer readable media.

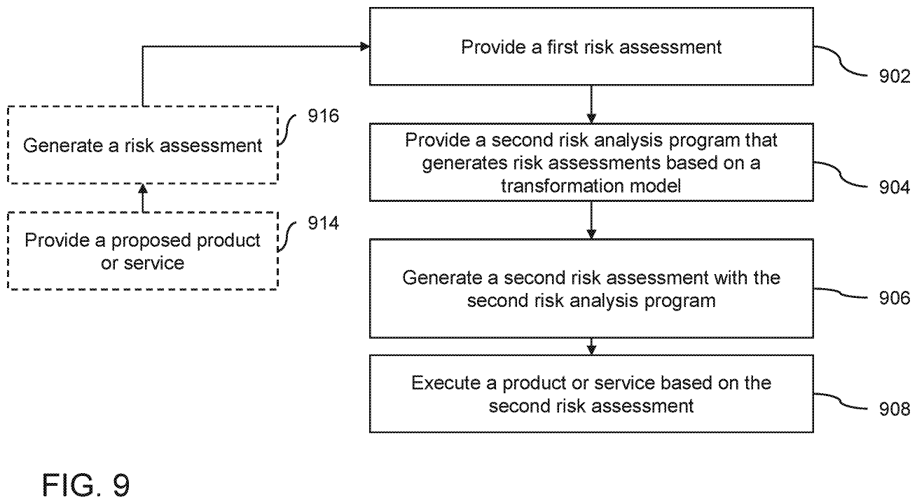

Referring to FIG. 9, an example embodiment of computer executable instructions for processing hierarchical data is shown.

At block 902, a first risk assessment is provided. In generating the transformation model 208, the first risk assessment is provided by the platform 10a. In examples where the transformation model 208 is already generated, the first risk assessment can be risk for individual instruments for the proposed transaction. The first risk assessment can be created by a risk platform 10a, local to the risk platform 10, or otherwise.

The platform 10 can periodically or constantly receive or pull the first risk assessments. For example, in a large institution, the platform 10 can be configured to perform risk re-analysis (alternatively referred to as a transitioned risk analysis) for trades or products surpassing a certain threshold (e.g., monetary, regulatory, etc.) automatically.

At block 904, a second risk analysis program (e.g., risk platform 10b) that generates risk assessments based on a transformation model (e.g., model 208) is provided. The second risk analysis program generates risk assessments based on a transformation model configured to convert risk based on (1) a first reference rate, and (2) one or more risk functions for one or more first instruments, into risk based on a second reference rate.

At block 906, a second risk assessment (e.g., assessment 209) with the is generated second risk analysis program. The second risk assessment can be based on based on the first risk assessment and one or more target instruments that incorporate risk based on the second reference rate, the one or more target instruments being associated with a product or service.

Optionally, at block 908, the product or service associated with the second risk assessment can be executed if the assessment satisfies one or more thresholds. For example, a trade can have as a final impediment to execution a requirement of a satisfied risk assessment.

Optionally, at blocks 914 and 916, the platform 10 can receive input for a proposed product or service, and generate a risk assessment, respectively. The risk assessment of block 916 can be risk assessments for the individual instruments that constitute the proposed transaction.

In example embodiments, as alluded to above, the method shown in FIG. 9 is at least in part automated. For example, the first risk assessment generated in proposed to a submitted trade, and the platform 10 can be configured to receive the first risk assessment automatically.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A device for transitioning risk analysis, the device comprising:
a processor;
a communications module coupled to the processor; and
a memory coupled to the processor, the memory storing computer executable instructions that when executed by the processor cause the processor to:
provide a first risk assessment;
provide a second risk analysis program that generates risk assessments based on a transformation model configured to convert risk based on (1) a first reference rate, and (2) one or more risk functions for one or more first instruments, into risk based on a second reference rate; and
generate a second risk assessment with the second risk analysis program, based on the first risk assessment and one or more target instruments that incorporate risk based on the second reference rate, the one or more target instruments being associated with a product or service.

2. The device of claim 1, wherein the instructions cause the processor to:
determine whether to execute the product or service in response to the second risk assessment satisfying a threshold based on the second reference rate.

3. The device of claim 1, wherein the first reference rate is determined by a LIBOR based instrument, and the second reference rate is determined with a SOFR based instrument.

4. The device of claim 1, wherein at least one of the one or more first instruments is structurally different than at least one corresponding instrument of the one or more target instruments, and the transformation model converts risk from the at least one corresponding instrument into a replacement instrument aligned with the corresponding instrument of the first set of instruments.

5. The device of claim 1, wherein the transformation model converts risk at least in part by evaluating currency risk for the one or more first instruments by converting at least some of the one or more first instruments into replacement instruments with a first structure, where the first structure corresponds to a structure of corresponding instruments of the one or more target instruments, and the replacement instruments differ from the corresponding target instruments in terms of currency funding.

6. The device of claim 1, wherein the transformation model converts risk in two or more stages, each stage being configured to isolate a different risk.

7. The device of claim 6, wherein at least one stage of the two or more stages isolates cross currency funding risk, and another of the two or more stages isolates misalignment risk.

8. The device of claim 7, wherein a further stage of the two or more stages receives an outcome of the at least one and other stage and determines risk based on the one or more target instruments.

9. The device of claim 1, wherein the instructions cause the processor to populate one or more risk buckets with risk assessed for one or more target instruments to reflect risk in the corresponding buckets.

10. The device of claim 1, wherein the instructions cause the processor to validate the second risk assessment by comparing the second risk assessment to a reference risk assessment.

11. A method for transitioning risk analysis, the method executed by a device having a communications module and comprising:
providing a first risk assessment;
providing a second risk analysis program that generates risk assessments based on a transformation model configured to convert risk based on (1) a first reference rate, and (2) one or more risk functions for one or more first instruments, into risk based on a second reference rate; and
generating a second risk assessment with the second risk analysis program, based on the first risk assessment and one or more target instruments that incorporate risk based on the second reference rate, the one or more target instruments being associated with a product or service.

12. The method of claim 11, further comprising determining whether to execute the product or service in response to the second risk assessment satisfying a threshold based on the second reference rate.

13. The method of claim 11, wherein the first reference rate is determined by a LIBOR based instrument, and the second reference rate is determined with a SOFR based instrument.

14. The method of claim 11, wherein at least one of the one or more first instruments is structurally different than at least one corresponding instrument of the one or more target instruments, and the transformation model converts risk from the at least one corresponding instrument into a replacement instrument aligned with the corresponding instrument of the first set of instruments.

15. The method of claim 11, wherein the transformation model converts risk at least in part by evaluating currency risk for the one or more first instruments by converting at least some of the one or more first instruments into replacement instruments with a first structure, where the first structure corresponds to a structure of corresponding instruments of the one or more target instruments, and the replacement instruments differ from the corresponding target instruments in terms of currency funding.

16. The method of claim 11, wherein the transformation model converts risk in two or more stages, each stage being configured to isolate a different risk.

17. The method of claim 16, wherein at least one stage of the two or more stages isolates cross currency funding risk, and another of the two or more stages isolates misalignment risk.

18. The method of claim 17, wherein a further stage of the two or more stages receives an outcome of the at least one and other stage and determines risk based on the one or more target instruments.

19. The method of claim 11, further comprising validating the second risk assessment by comparing the second risk assessment to a reference risk assessment.

20. A non-transitory computer readable medium for transitioning risk analysis, the computer readable medium comprising computer executable instructions for:
providing a first risk assessment;
providing a second risk analysis program that generates risk assessments based on a transformation model configured to convert risk based on (1) a first reference rate, and (2) one or more risk functions for one or more first instruments, into risk based on a second reference rate; and
generating a second risk assessment with the second risk analysis program, based on the first risk assessment and one or more target instruments that incorporate risk based on the second reference rate, the one or more target instruments being associated with a product or service.
